(19) United States
(12) Patent Application Publication
(10) Pub. No.: US 2018/0330143 A1
(43) Pub. Date: Nov. 15, 2018

(54) DIGITAL IMAGING AND ANALYSIS SYSTEM FOR USE IN EXTREME WEATHER CONDITIONS

(71) Applicant: The Board of Regents, The University of Texas System, Austin, TX (US)

(72) Inventors: Gesuri Ramirez, El Paso, TX (US); Geovany Ramirez, El Paso, TX (US); Craig Tweedie, El Paso, TX (US); Emmanuel Ochoa, South San Francisco, CA (US)

(21) Appl. No.: 16/028,348

(22) Filed: Jul. 5, 2018

Related U.S. Application Data
(63) Continuation-in-part of application No. 15/202,890, filed on Jul. 6, 2016.
(60) Provisional application No. 62/189,278, filed on Jul. 7, 2015.

(51) Int. Cl. G06K 9/00; G06T 7/11; G01J 3/28; G03B 17/02

(52) U.S. Cl. CPC G06K 9/0063; G06T 7/11; G01J 2003/2826; G03B 17/02; G06K 2009/00644; G01J 3/2823

(57) ABSTRACT

A digital imaging and analysis system configured to provide sensor triggered events is presented. The system comprises detection and control components in communication with each other. The detection and control components comprise a plurality of sensors configured to gather at least one of environmental data or images; and a primary board in direct or indirect communication with the plurality of sensors and configured to trigger one of the plurality of sensors in response to another of the plurality of sensors exceeding an environmental threshold.

### CROSS-REFERENCE TO RELATED APPLICATIONS

This application is a continuation-in-part of prior co-pending U.S. patent application Ser. No. 15/202,890 entitled “Digital Imaging and Analysis System,” and filed on Jul. 6, 2016 that claims the benefit under 35 U.S.C. § 119(e) to U.S. Provisional Patent Application Ser. No. 62/189,278 filed on Jul. 7, 2015, entitled “Digital Imaging and Analysis System,” both of which are hereby incorporated by reference in their entirety.

### TECHNICAL FIELD

Embodiments are related to digital cameras, environmental data logger, image processing systems and techniques, and analytical software development. Embodiments further relate to the acquisition and analysis of imagery acquired by multispectral digital cameras. Embodiments also relate to digital cameras and data loggers that can be utilized in rugged and remote environments.

### BACKGROUND

Over the past decade, environmental scientists have increasingly used low-cost sensors and custom software to gather and analyze environmental data. Included in this trend has been the use of imagery from digital cameras and data loggers. Published literature has highlighted the challenge scientists have encountered with poor and problematic camera and logger performance and power consumption, limited capacity for the acquisition of coupled environmental data, limited capacity for ‘smart’ sensors to trigger altered measurement states based on environmental thresholds, limited data download and wireless communication options, general ruggedness of off the shelf camera solutions, and time consuming and hard-to-reproduce digital image analysis options.

### SUMMARY

The following summary is provided to facilitate an understanding of some of the innovative features unique to the disclosed embodiments and is not intended to be a full description. A full appreciation of the various aspects of the embodiments disclosed herein can be gained by taking into consideration the entire specification, claims, drawings, and abstract as a whole.

It is, therefore, one aspect of the disclosed embodiments to provide for an improved digital imaging, data logging, and analysis system and method thereof.

It is another aspect of the disclosed embodiments to provide for a coupled camera-logger system that can be employed to acquire imagery and other data from a fixed point and/or a moving platform.

The aforementioned aspects and other objectives and advantages can now be achieved as described herein. Digital image and analysis methods and systems are disclosed. A weatherproof housing to aid deployment and maintenance of the camera logger under harsh conditions can encase the digital camera and a logger. The digital camera and logger is electronically associated with a memory to which imagery and data acquired by the digital camera and sensors respectively is saved. The digital camera and logger can be customized and pre-programmed and the imagery and data can be analyzed with custom software, which also produces custom visualizations. One or more sensors can communicate electronically with the logger and can be triggered to permit the digital cameras to acquire repeat digital imagery and movies of the same image footprint in RGB, HSV, L*a*b*, thermal, and Near Infrared color spaces. Selectable regions of interest with respect to the imagery can be saved in the memory and are used to analyze spectral changes in the region of interest over time (repeat imagery).

In some example embodiments, environmental thresholds from one or more of the sensors linked to the data logger can be programmed to trigger the camera systems. In another example embodiment, the RGB digital image sensor can be configured to permit the imagery acquired by the digital camera to be viewed in RGB, HSV, and L*a*b* color spaces. In some example embodiments, sensors may be implemented as a group of imaging sensors including an image sensor, a thermal sensor, a long-wavelength infrared sensor, and/or a combination of such sensors. In still other example embodiments, at least one sensor can be implemented as an image sensor and at least one other sensor can be implemented as a thermal sensor. In yet other example embodiments, the sensors can be composed of an RGB digital image sensor, a true near infrared sensor, and a thermal sensor. In still another example embodiment, the aforementioned thermal sensor can be a long-wavelength infrared sensor and the RGB digital image sensor can pemlit the imagery acquired by the digital camera to be viewed in RGB, HSV, and L *a*b* color spaces.

In another example embodiment, a digital imaging and analysis system can be implemented, which includes: a digital camera encased by a weather-proof housing for easy deployment and maintenance of the digital camera and its protection under harsh conditions, which is associated with a memory to which imagery acquired by the digital camera is saved; wherein the digital camera is configured to be customized and preprogrammed, wherein imagery is subject to custom visualization; a plurality of sensors electronically associated with the digital camera which are triggered to permit the digital camera to acquire the imagery and image a same image footprint of the imagery in at least one color space; and wherein selectable regions of interest with respect to the imagery are saved in the memory.

In still another example embodiment, a method of configuring a digital imaging and analysis system can be implemented. Such an example method may include steps such as, for example, encasing a digital camera with a weather-proof housing for deployment and maintenance of the digital camera under harsh conditions, which is associated with a memory to which imagery acquired by the digital camera is saved; configuring the digital camera to be customized and pre-programmed, wherein imagery is subject to custom visualization; and electronically associating a plurality of sensors with the digital camera, wherein the plurality of sensors is triggerable to permit the digital camera to acquire the imagery and image a same image footprint of the imagery in at least one color space, and wherein selectable regions of interest can be analyzed for their spectral properties over the time series imagery saved in the memory.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a pictorial view of a camera system, which can be employed to acquire imagery from a fixed point and/or a moving platform, in accordance with a preferred example embodiment;

FIG. 2 illustrates a pictorial view of the camera system of FIG. 1 mounted in the context of a field deployment on top of a tower, in accordance with an alternative example embodiment;

FIG. 3 illustrates a screen shot of an example GUI that can be employed for the configuration of the camera system shown in FIGS. 1-2, in accordance with a preferred example embodiment;

FIG. 4 illustrates example images capable of being acquired by the camera system shown in FIGS. 1-2, in accordance with a preferred example embodiment;

FIG. 5 illustrates a screen shot of an example GUI that car, be employed for digital image analysis, in accordance with a preferred example embodiment;

FIGS. 6A-6B illustrate example plots resulting from a digital image analysis involving an HSV color space, in accordance with a preferred example embodiment;

FIG. 7 illustrates a flow chart of operations depicting logical operational steps of a method for digital image analysis with respect to the disclosed camera system, in accordance with an alternative example embodiment;

FIG. 8 illustrates a schematic view of a computer system, in accordance with an example embodiment;

FIG. 9 illustrates a schematic view of a software system including a module, an operating system, and a user interface, in accordance with an example embodiment;

FIG. 10 illustrates a block diagram of a digital imaging, logging, and analysis system, which can be implemented in accordance with an example embodiment;

FIG. 11 illustrates a block diagram of a digital imaging, logging, and analysis system, which can be implemented in accordance with another example embodiment;

FIG. 12 illustrates a block diagram of a digital imaging, logging, and analysis system, which can be implemented in accordance with yet another example embodiment;

FIG. 13 is an illustration of a block diagram of a digital imaging and analysis system in accordance with an illustrative embodiment;

FIG. 14 is an illustration of a block diagram of a primary board of a digital imaging and analysis system in accordance with an illustrative embodiment;

FIG. 15 is an illustration of a functional block diagram of a primary board of a digital imaging and analysis system in accordance with an illustrative embodiment;

FIG. 16 is an illustration of a diagram of a modularized board of a digital imaging and analysis system in accordance with an illustrative embodiment;

FIG. 17 is an illustration of a diagram of a remote module of a digital imaging and analysis system in accordance with an illustrative embodiment;

FIG. 18 is an illustration of a functional diagram of a remote panel in accordance with an illustrative embodiment;

FIG. 19 is an illustration of a functional diagram of a remote module in accordance with an illustrative embodiment; and

FIG. 20 is an illustration of a flowchart for monitoring a data gathering environment using a digital imaging and analysis system in accordance with an illustrative embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to identical, like or similar elements throughout, although such numbers may be referenced in the context of different embodiments. As used herein, the term “and/or” includes any and all combinations of one or more of the associated listed items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 illustrates a pictorial view of a camera and environmental sensing and logger system 10, which can be employed to acquire imagery and data from attached sensors from a fixed point and/or a moving platform, in accordance with a preferred embodiment. The camera and logger system 10 is shown in FIG. 1 with its major components 12. The camera and logger system 10 can be employed to obtain images from a fixed point (e.g., building, tower, post) and/or a moving platform (e.g., car, ATV, boat, UAV, aircraft, etc.). An external computer or data logging device is not needed for operation of the camera and logging system 10, but may be linked if needed for purposes such as control-enabled or enhanced real-time communication and image/data processing, linking to other sensor systems, etc.

In a preferred embodiment, the camera system 10 is battery powered and the battery system is recharged from solar or wind-powered charging systems. In alternative embodiments, however, the camera and logger system 10 is capable of being connected to line power (e.g., AC, USB, power over Ethernet) or an alternate energy source for remote deployment (e.g., wind, fuel cell). All hardware components are enclosed in a weather proof housing designed for easy deployment and maintenance and protection against the harsh conditions these systems have been designed for and are expected to run in (i.e., can be deployed and serviced with winter gloves on, gaskets are designed to handle repeat freeze-thaw expansion and contraction, etc.).

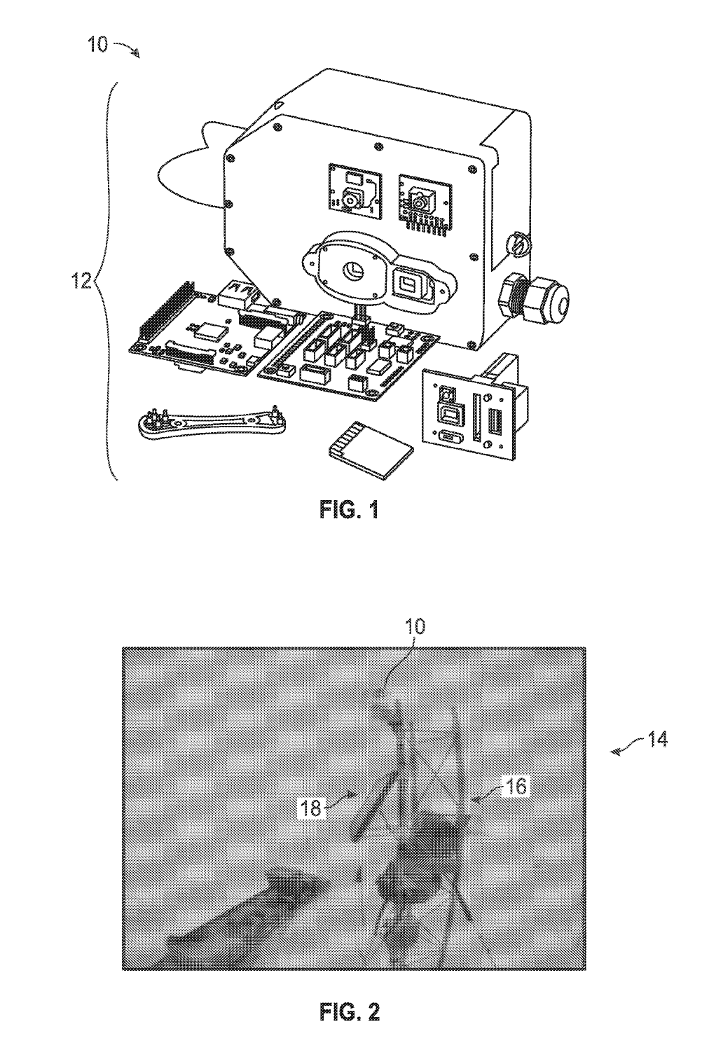

FIG. 2 illustrates a pictorial view 14 of the camera and logger system 10 of FIG. 1 mounted in the context of a field deployment on top of a tower 16, in accordance with an alternative embodiment. FIG. 2 indicates that the camera and logger system 10 can be implemented in rugged and remote environments and with a solar panel 18, which collects solar energy for powering the battery system 10 as it collects data.

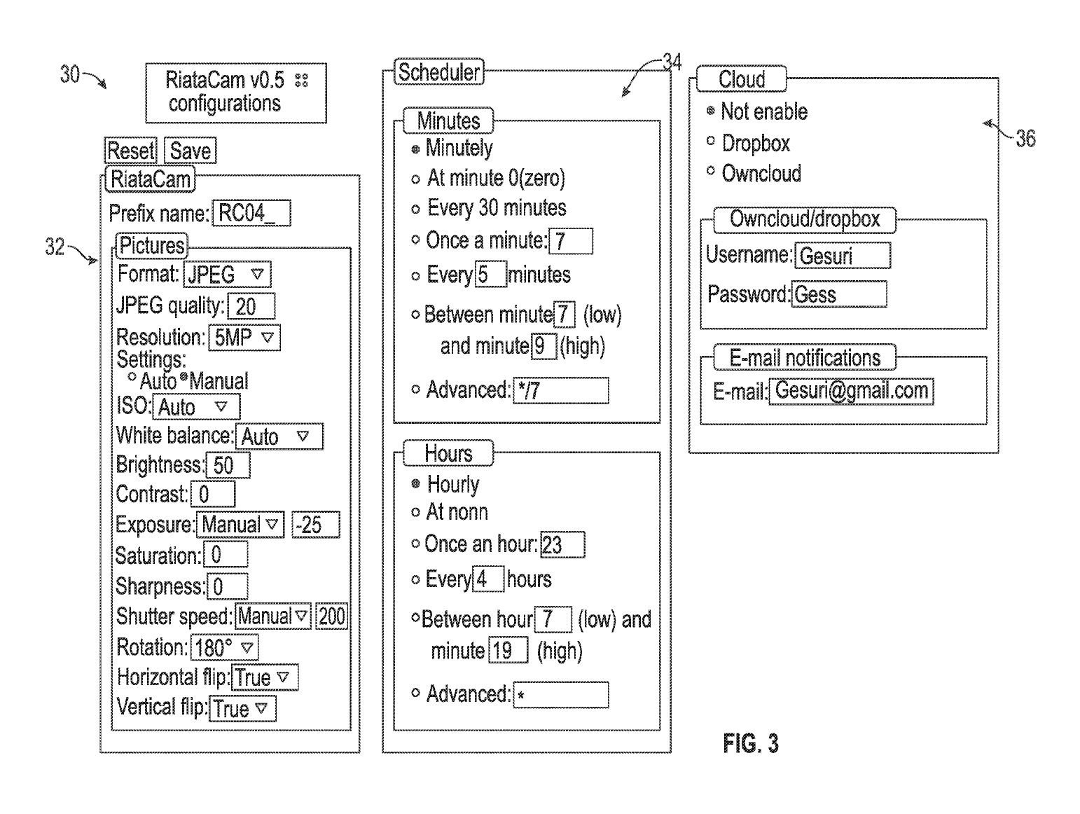

FIG. 3 illustrates a screen shot of an example GUI (Graphical User Interface) 30 that can be employed for the configuration of the camera system 10 shown in FIGS. 1-2, in accordance with a preferred embodiment The GUI 30 includes a picture section 32 that allows a user to configure the camera system 10 according to format type, quality, brightness, balance, and so on. GUI 30 also includes a scheduler section 34 that a user can access to set various activities based on hours, minutes, etc. GUI 30 further includes a “cloud” section 36 that a user can access to configure settings such as cloud storage and email notification options. All hardware components of the camera and logger system 10 are preferably enclosed in a weather proof housing designed for easy deployment and maintenance and protection against harsh environmental conditions (i.e., can be deployed and serviced with winter gloves, etc.).

Note that the term “GUI” or “Graphical user Interface” as utilized herein refers to an interface that allows a user to interact with electronic devices such as the camera and logger system 10 through, for example, graphically displayed icons and visual indicators such as secondary notation (as opposed to text-based interfaces), typed command labels, or text navigation. The actions in a GUI can be performed through direct manipulation of the graphical elements

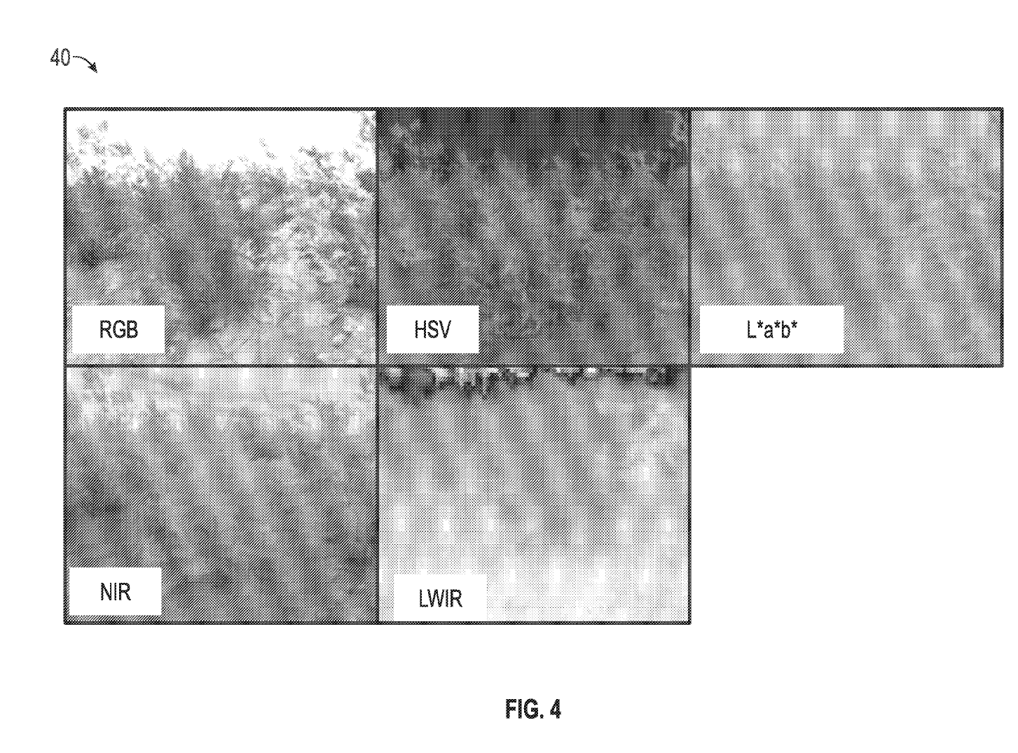

FIG. 4 illustrates example images 40 capable of being acquired by the camera and logger system 10 shown in FIGS. 1-2, in accordance with a preferred embodiment. The camera and logger system 10 can function in association with a variety of digital imaging sensors such as, for example, an RGB sensor, a true near Infrared sensor, and a thermal sensor as well as a range of environmental sensors that connect to the logger (e.g., commercial off the shelf or custom temperature, relative humidity, wind speed, wind direction, soil moisture, surface wetness). Thus, imagery acquired by the camera can include a digital image sensor in RGB (allows for imagery to be viewed in RGB, HSV, and L*a*b* color space), a true near Infrared sensor, and a thermal sensor (long-wavelength infrared). All sensors can be triggered to acquire imagery at the same time and for the same footprint.

The images 40 shown in FIG. 4 illustrate example imagery captured from the camera system in the northern Chihuahuan Desert Digital imagery is shown in RGB, HSV, and L*a*b* color space (top). Imagery from the IR sensor and thermal sensor are also shown (bottom left and right, respectively). Note that as utilized herein, l*a*b (or “Lab”) color space refers to a color-opponent space with dimension L for lightness and a and b for the color-opponent dimensions, based on nonlinearly compressed (e.g., CIE XYZ color space) coordinates.

The l*a*b* color space includes all perceivable colors, which means that its gamut exceeds those of the RGB and CMYK color models. One of the most important attributes of the l*a*b*-model is device independence. This means that the colors are defined independent of their nature of creation or the device they are displayed on. The l*a*b* color space can be used, for example, when graphics have to be converted from RGB to CMYK, as the l*a*b* gamut includes both the RGB and CMYK gamut. Also, it is used as an interchange format between different devices as for its device independency.

In some embodiments, imagery can be acquired at a resolution of 8 megapixels and can be stored in a range of standard file formats including JPEG, GIF, TIF, PNG, RAW. Video may also be obtained from the aforementioned sensor(s) in RGB or IR in full HD {e.g., 1080) or whole sensor resolution {e.g., 3264×2448). A range of analogue and/or digital sensors (temperature, motion, wind speed and direction, soil moisture, light, etc.) used by environmental scientists can be attached directly to the camera system, which can be programmed to record data as per a traditional data logger (e.g., 16 Bit). Such data can be stored in some embodiments in .csv files or in a binary file format.

Image and auxiliary data (i.e., additional sensors) can be acquired in response to a variety of triggers including time interval, external device {e.g., mechanical switch, computer, other instrument), and sensor state (e.g., commercial off the shelf or custom moisture, motion, and readout from other sensors). Communication to/from the camera and logger system includes a range of standardized options such as Wi-Fi, Bluetooth, Ethernet, USB, serial, GSM, and Iridium satellite phone. In some embodiments, data may also be downloaded from an SD card.

The camera and logger system 10 is programmable (e.g., Python, C, C++, Java, HTML) and users can either program their own functionality or use a custom interface to configure and control all aspects of its operation (time/event triggers for data acquisition, file format, file naming convention, image resolution, ISO, white balance, brightness, contrast, exposure, sharpness, saturation, shutter speed vertical/horizontal flip), communication, and telemetry, etc.

Users can setup diagnostics record files that include periodic recording of battery voltage, solar charging strength, Wi-Fi signal strength, and data transfer failures, etc. Diagnostic files and/or system failure can be downloaded as described below. Options for data transfer are also diverse. Users can download data manually using the range of options listed above, program the system to send data via email and/or social media (e.g., Facebook, Twitter), and/or send data to a server or cloud {e.g., Dropbox, Amazon, Google, other). Hence, the “cloud” configuration section 36 shown in FIG. 3. Note that the term “Wi-Fi” as utilized herein refers to WiFi, a communications technology that allows electronic devices to connect to a wireless LAN (local area network) mainly using the 2.4 gigahertz (12 cm) UHF and 5 gigahertz (6 cm) SHF ISM radio bands.

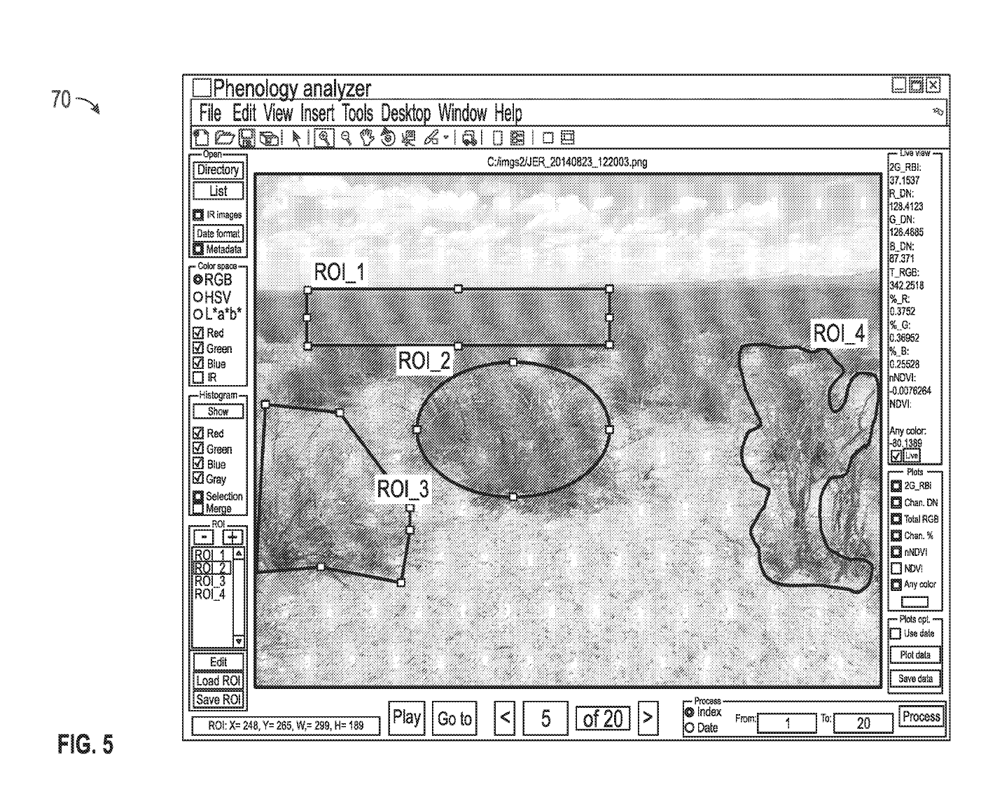

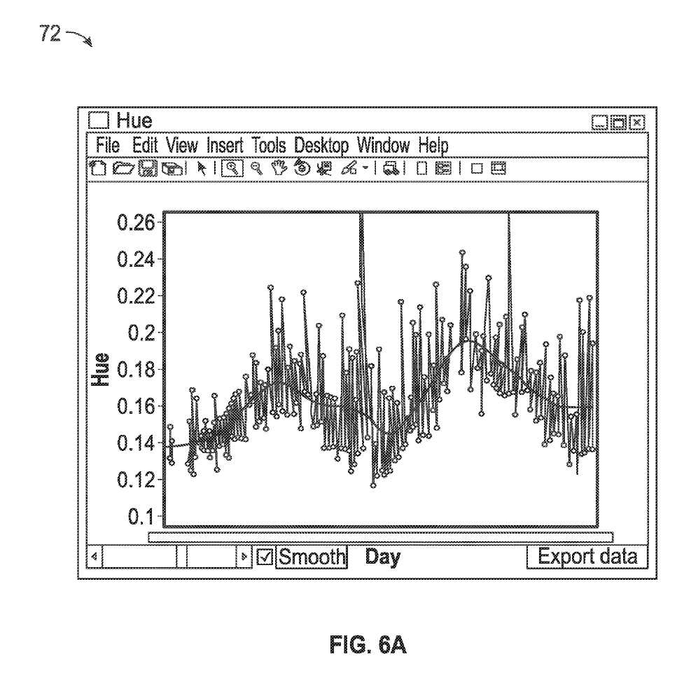

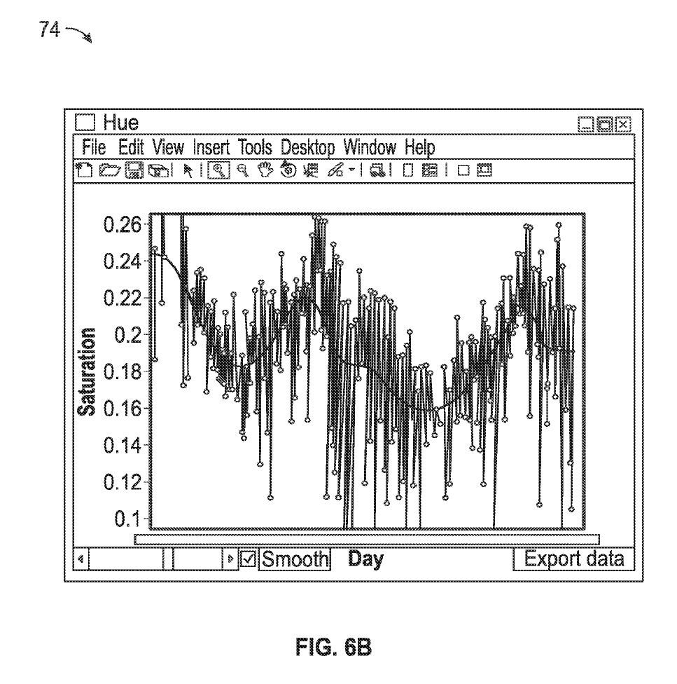

FIG. 5 illustrates a screen shot of an example GUI 70 that can be employed for digital image analysis, in accordance with a preferred embodiment. FIGS. 6A-6B illustrate example plots 72, 74 resulting from a digital image analysis of HSV color space, in accordance with a preferred embodiment. Image analysis software can be used to analyze imagery acquired by camera system 10 and/or acquired in standard file formats by other camera systems. The software can be installed within a few minutes and is compatible with MS Windows, Apple OSX, and Linux operating systems. Imagery can be loaded from a folder of imagery viewed as thumbnails or a text files with the list of images. Imagery metadata can also be viewed.

Users can scroll through the sequence of imagery using forward/backward buttons at the bottom of the software interface. Imagery can be viewed in RGB, HSV, and l*a*b* color space and each channel can be turned off/on separately to enhance image discovery and analysis.

In the lower left section of the GUI 70, users can define a region of interest (ROI) for analysis. ROI's can have multiple shapes (rectangle, ellipse, geometric (polygon) and/or be drawn in ‘freehand’). Multiple ROIs can also be established for a given analysis and users can save the ROI's and load these in future analyses to ensure sampling footprints are fixed between analyses. When an ROI has been selected, readout for the selected color space appears in the ‘live view’ section of the user interface (upper right of GUI 70).

Users can then select a spectral index, which have been derived from published literature and are generally accepted by the scientific community, and/or choose to have analytical output reported as separate channel strengths for a given color space. When the analysis has been configured with a choice of folder and associated files, color space, ROIs, and spectral indices, users then choose to view the analysis in a plot and press the process button to execute the analysis. The software can typically process and plot results from a years' worth of data collection in a few minutes. Results of the analysis can be viewed in a plot and/or downloaded as, for example, a .csv file for additional analysis and visualization.

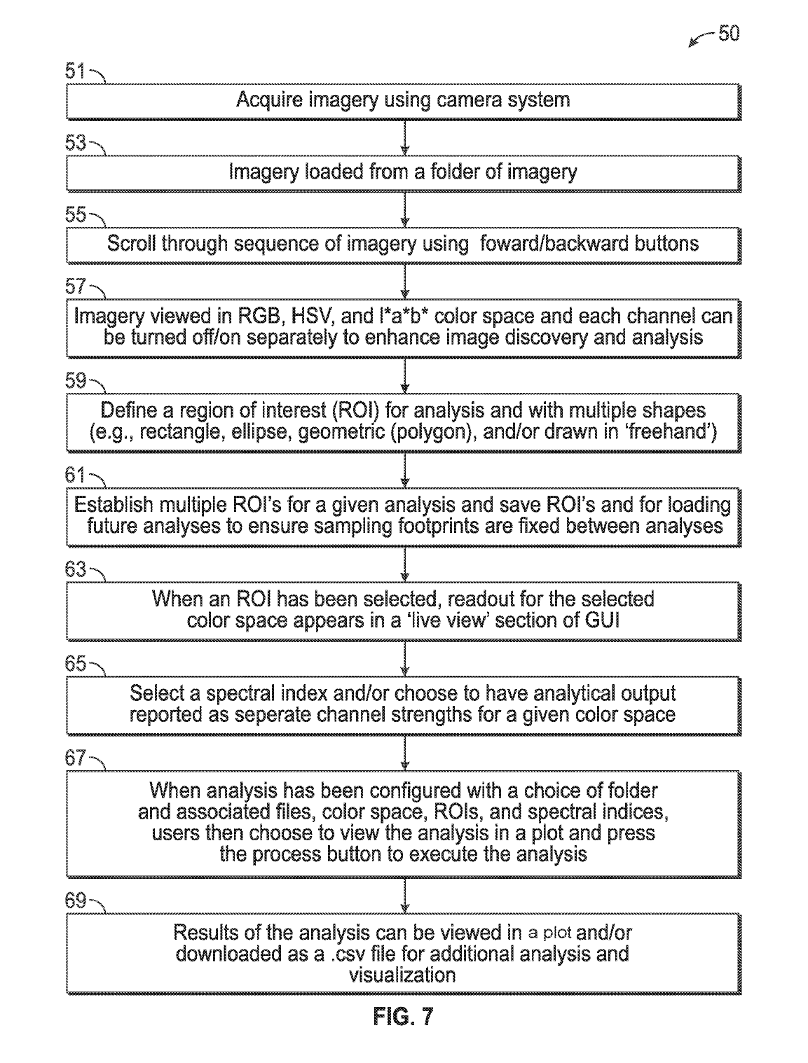

FIG. 7 illustrates a flow chart of operations depicting logical operational steps of a method 50 for digital image analysis with respect to the disclosed camera and logger system 10, in accordance with an alternative embodiment. As indicated at block 51, imagery can be acquired using the disclosed camera and logger system 10. The imagery can be loaded, as indicated at block 53, from a folder of imagery viewed as thumbnails or a text file with the list of images. Imagery metadata can also be viewed as indicated previously. As shown next at block 55, users can scroll through the sequence of imagery using forward/backward buttons at the bottom of the GUI 70 discussed above.

As depicted next at block 57, imagery can be viewed via the GUI 70 in RGB, HSV, and l *a*b° ′ color space and each channel can be turned off/on separately to enhance image discovery and analysis. As illustrated at block 59, users may define via the GUI 70, a region of interest (ROI) for analysis. As discussed above, ROI's can have multiple shapes (rectangle, ellipse, geometric (polygon), and/or be drawn in ‘freehand’). Multiple ROIs can also be established, as depicted at block 61, for a given analysis and users can save the ROI's and load these in future analyses to ensure sampling footprints are fixed between analyses.

When an ROI has been selected as shown at block 63, readout for the selected color space appears in the ‘live view’ section of the GUI. Users can then select, as depicted at block 65, a spectral index, which are derived from published literature and are generally accepted by the scientific community, and/or choose to have analytical output reported as separate channel strengths for a given color space.

When the analysis has been configured with a choice of folder and associated files, color space, ROIs, and spectral indices, users can choose to view the analysis in a plot and press the process button to execute the analysis, as indicated at block 67. The software can typically process and plot results from a years' worth of data collection in a few minutes. Results of the analysis can be viewed in a plot and/or downloaded as a .csv file for additional analysis and visualization, as shown at block 69.

As can be appreciated by one skilled in the art, embodiments can be implemented in the context of a method, data processing system, or computer program product. Accordingly, embodiments may take the fom1 of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USS Flash Drives, DVDs, CD-ROMs, optical storage devices, magnetic storage devices, server storage, databases, etc.

Computer program code for carrying out operations of the present invention may be written in an object oriented programming language {e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wi-Fi, Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

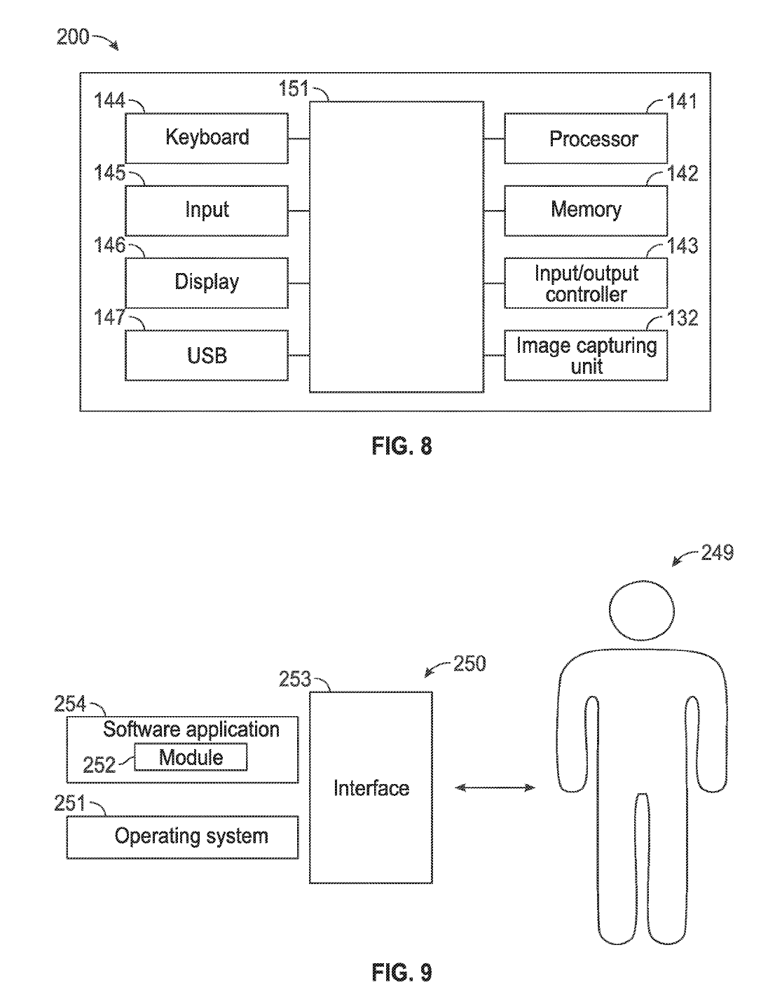

FIGS. 8-9 are provided as exemplary diagrams of data-processing environments in which embodiments of the present invention may be implemented. It should be appreciated that FIGS. 8-9 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 8, some embodiments may be implemented in the context of a data-processing system 200 that includes, for example, a processor 141 such as a CPU, a memory 142, an input/output controller 143, an image capturing unit or camera(s) 132, a keyboard 144, an input device 145 {e.g., a pointing device, such as a mouse, track ball, and pen device, etc.), a display 146, and a USB {Universal Serial Bus) peripheral connection 147. As illustrated, the various components of data-processing system 200 can communicate electronically through a system bus 151 or similar architecture.

The system bus 151 may be, for example, a subsystem that transfers data between, for example, computer components within data-processing system 200 or to and from other data-processing devices, components, computers, etc. It can be appreciated that some of the components shown in FIG. 8 are optional and desirable only in certain situations. For example, the image-capturing unit 132 may or not be included with data processing system 200, but may be desirable in the case of, for example, Smartphone or laptop computer implementations, which often include a video camera. In a preferred embodiment, however, the image-capturing unit 132 may be implemented as or in association with the camera system 10 depicted in FIG. 1.

FIG. 9 illustrates a computer software system 250 for directing the operation of the data-processing system 200 depicted in FIG. 9. Software application 254 stored, for example, in memory 142 generally includes a kernel or operating system 251 and a shell or interface 253. One or more application programs, such as software application 254, may be “loaded” (i.e., transferred from, for example, a mass storage or other memory location into the memory 142) for execution by the data-processing system 200. The data-processing system 200 can receive user commands and data through an interface 253; these inputs may then be acted upon by the data-processing system 200 in accordance with instructions from operating system 251 and/or software application 254. The interface 253 in some embodiments can serve to display results, whereupon a user 249 may supply additional inputs or terminate a session. The software application 254 can include a module 252 that can implement instructions or logical operations such as those described herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

The module 252 shown in FIG. 9 can thus implement instructions such as those shown and described and illustrated herein with respect to, for example, FIG. 7. It can be appreciated, however, that such blocks/operations and instructions thereof are not limiting features of the disclosed embodiments. Other operations can be implemented with or in lieu of such instructions/operations.

FIGS. 8-9 are intended as examples and not as architectural limitations of disclosed embodiments. Additionally, such embodiments are not limited to any particular application or computing or data processing environment Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

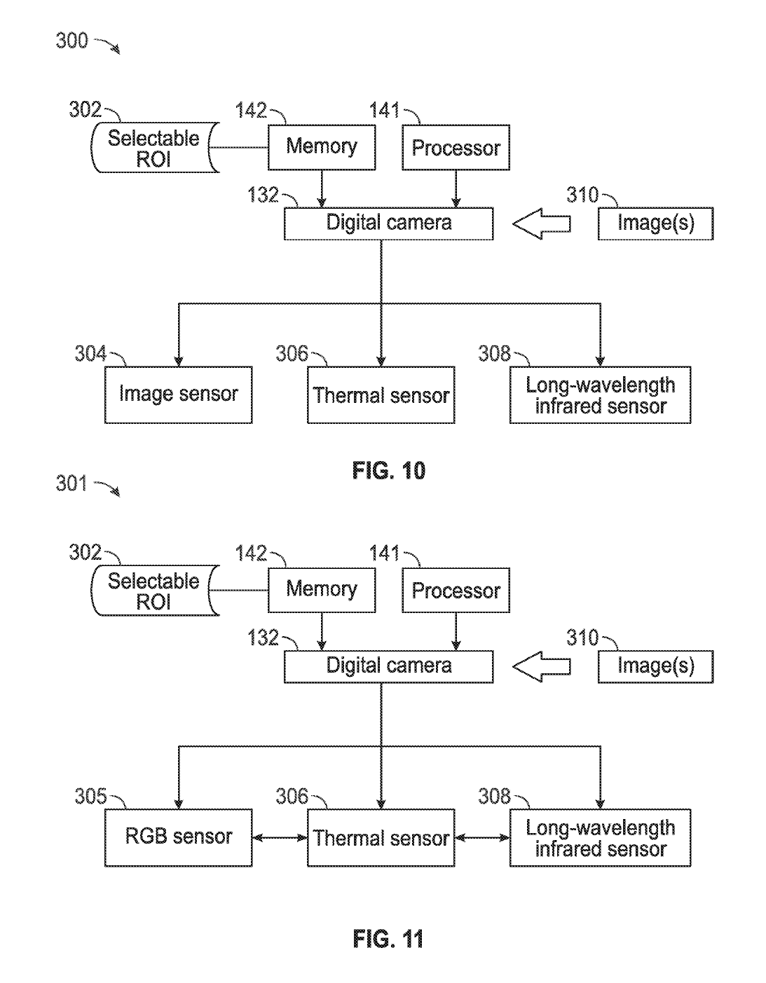

FIG. 10 illustrates a block diagram of a digital imaging and analysis system 300, which can be implemented in accordance with an example embodiment. In the example embodiment shown in FIG. 10, the system 301 can include a digital camera 132 that is encased by a weather-proof housing that allows the digital camera 132 to be deployed and maintained in harsh conditions as discussed previously. The digital camera 132 is associated or operably connected to memory 142 and/or a processor 141 (e.g., a CPU or other type of processor). An image 310 can be acquired by the digital camera 132 and saved in the memory 142 as digital data including, for example, data indicative of a selectable ROI (Region of Interest) 302. The digital camera and logger system 132 can be customized and pre-programmed (i.e., programmed beforehand or prior to deployment of the digital camera 132). The image (e.g., image 310) can be subject to custom visualization.

The system 300 can additionally include a group of sensors that includes, for example, an image sensor 304, a thermal sensor 306, and a long-wavelength near infrared sensor 308. Such sensors can be triggered to permit the digital camera to acquire imagery (e.g., image 310) and image the same image footprint with respect to the image 310 in, for example, one or more color spaces such as RGB, HSV, l*a*b* color spaces. The sensors 304, 306, and 308 are preferably electronically and operably connected to the digital camera 132. The selectable ROI 302 with respect to the acquired image 310 is saved in the memory 142.

FIG. 11 illustrates a block diagram of a digital imaging and analysis system 301, which can be implemented in accordance with an example embodiment. The example embodiment shown in FIG. 11 is similar to the embodiment depicted in FIG. 10, the difference being that an RGB digital image sensor 305 is shown in association with the other sensors 306, 308. Also, in the example embodiment depicted in FIG. 11, the RGB sensor 305, the thermal sensor 306, and the long-wavelength infrared sensor 308 can communicate electronically with one another in addition to being operably connected to the digital camera 132. The ability for the sensors 305, 306, and 308 to communicate with one another may be helpful in cases where the sensors 305, 306, and 308 may need to be synchronized with one another for a particular action or exchange of data.

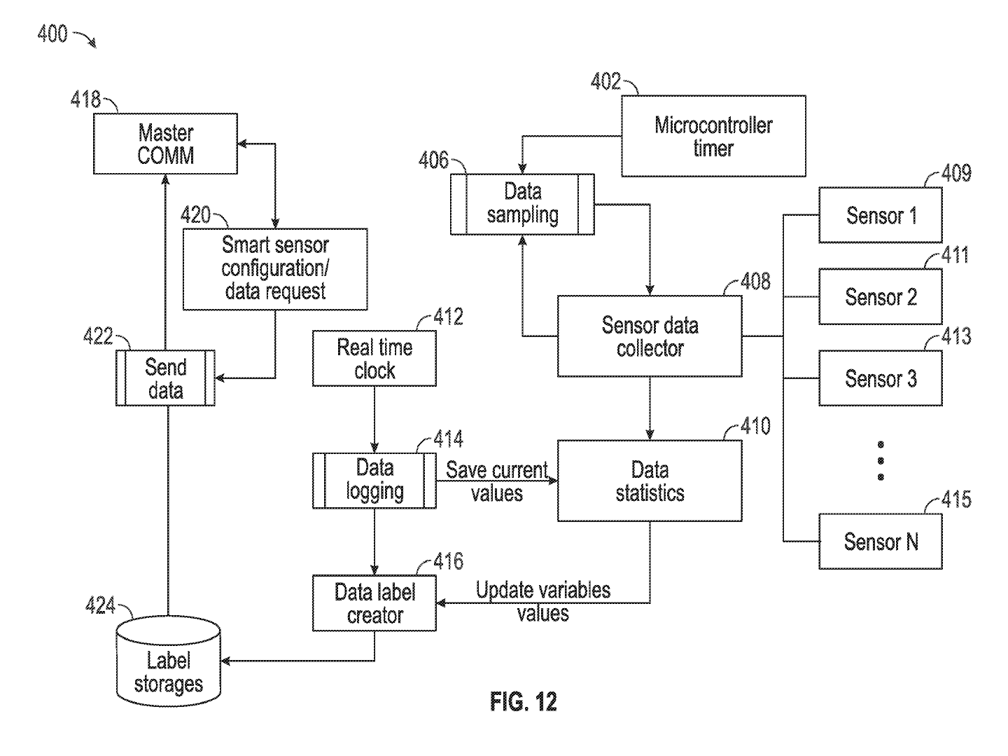

FIG. 12 illustrates a block diagram of a digital imaging, logging, and analysis system 400, which can be implemented in accordance with yet another example embodiment. In the example shown in FIG. 12, a group of sensors 409, 411, 413, and 415 can provide data to a sensor data collector 408, which operates with respect to a data sampling unit 406. A microcontroller timer 402 controls the data sampling unit 406 (and hence rates of data sampling). The data sampling unit 406 provides data which is input to the sensor data collector 408. The sensor data collector 408 generates data statistics 410 that provides as update variable values to a data label creator 416. A data logging unit 414 provides data which is input to the data label creator 416. The data logging unit 414 (i.e., which provides a data logging operation) also saves current values which are input with respect to the data statistics 410. A real time dock 412 is also operably connected to the data logging unit 414. A master COMM 418 is also shown in FIG. 12 and provides a smart sensor configuration/data request 420 which in turn operates with respect to a “send data” operation 422. That is, data stored in a label storages database 424 is sent to the master COMM 418 as facilitated by the send data operation 422. The database 424 also receives data from the data label creator 416.

Based on the foregoing, it can be appreciated that a number of example embodiments, preferred and alternative, are disclosed herein. For example, in one embodiment, a digital imaging and analysis system can be implemented. Such an example system can include a digital camera and logger encased by a weather-proof housing for easy deployment and maintenance and protection from harsh conditions, which is associated with a memory to which imagery acquired by the digital camera and logger is saved, wherein the digital camera is configured to be customized and pre-programmed, and wherein imagery is subject to custom visualization; a plurality of sensors electronically associated with the digital camera which are triggered to permit the digital camera to acquire the imagery and image a same image footprint of the imagery in RGB, HSV, l*a*b* color spaces. Additionally, selectable regions of interest with respect to the imagery are saved in the memory.

In some example embodiments, at least one sensor among the plurality of sensors can be an RGB digital image sensor. In yet another example embodiment, the RGB digital image sensor permits the imagery acquired by the digital camera to be viewed in HSV and L *a*b* color spaces. In some example embodiments, at least one sensor among the plurality of sensors can be, for example, an image sensor, a thermal sensor, a long-wavelength near-infrared sensor, and/or a combination of all such sensors. In still other example embodiments, at least one sensor among the plurality of sensors can be an image sensor and at least one other sensor among such sensors can be a thermal sensor. In other example embodiments, the plurality of sensors can be composed of an RGB digital image sensor, a true near infrared sensors, and a thermal sensor. In still another example embodiment, the aforementioned thermal sensor can be a long-wavelength infrared sensor and the RGB digital image sensor can permit the imagery acquired by the digital camera to be viewed in HSV and L *a*b* color spaces.

In another example embodiment, a digital imaging and analysis system can be implemented, which includes: a digital camera encased by a weather-proof housing for easy deployment and maintenance and protection from harsh conditions, which is associated with a memory to which imagery acquired by the digital camera is saved, wherein the digital camera is configured to be customized and pre-programmed, and wherein imagery is subject to custom visualization; a plurality of sensors electronically associated with the digital camera which are triggered to permit the digital camera to acquire the imagery and image a same image footprint of the imagery in at least one color space; and wherein selectable regions of interest with respect to the imagery are saved in the memory.

In still another example embodiment, a method of configuring a digital imaging and analysis system can be implemented. Such an example method may include steps such as, for example, encasing a digital camera with a weather-proof housing for deployment and maintenance of the digital camera and logger system under harsh conditions, which is associated with a memory to which imagery acquired by the digital camera is saved; configuring the digital camera to be customized and pre-programmed, wherein imagery is subject to custom visualization; and electronically associating a plurality of sensors with the digital camera, wherein the plurality of sensors is triggerable to permit the digital camera to acquire the imagery and image a same image footprint of the imagery in at least one color space, and wherein selectable regions of interest with respect to the imagery are saved in the memory.

In yet another embodiment, a digital imaging, environmental sensing and analysis system can be implemented which includes one or more multi-spectral digital cameras and a data logger encased by a weather-proof housing for easy deployment and maintenance and protection of the digital camera and the data logger from harsh conditions, which is associated with a memory to which imagery acquired by the digital camera is saved, wherein the digital camera is configured to be customized and pre-programmed, wherein imagery is subject to custom visualization; a plurality of sensors electronically associated with the digital camera wherein data is stored and triggered to permit the digital camera to acquire the imagery and image a same image footprint of the imagery in RGB, HSV, l*a*b* color spaces; and wherein selectable regions of interest with respect to the imagery are saved in the memory.

In still another embodiment, a digital imaging and analysis system can be implemented, which includes a digital camera encased by a weather-proof housing for easy deployment and maintenance of the digital camera and a logger and protection from harsh conditions, which is associated with a memory to which imagery acquired by the digital camera is saved; wherein the digital camera is configured to be customized and pre-programmed, wherein imagery is subject to custom visualization; a plurality of sensors electronically associated with the digital camera which are triggered to permit the digital camera to acquire the imagery and image a same image footprint of the imagery in at least one color space; and wherein selectable regions of interest with respect to the imagery are saved in the memory (e.g., computer memory).

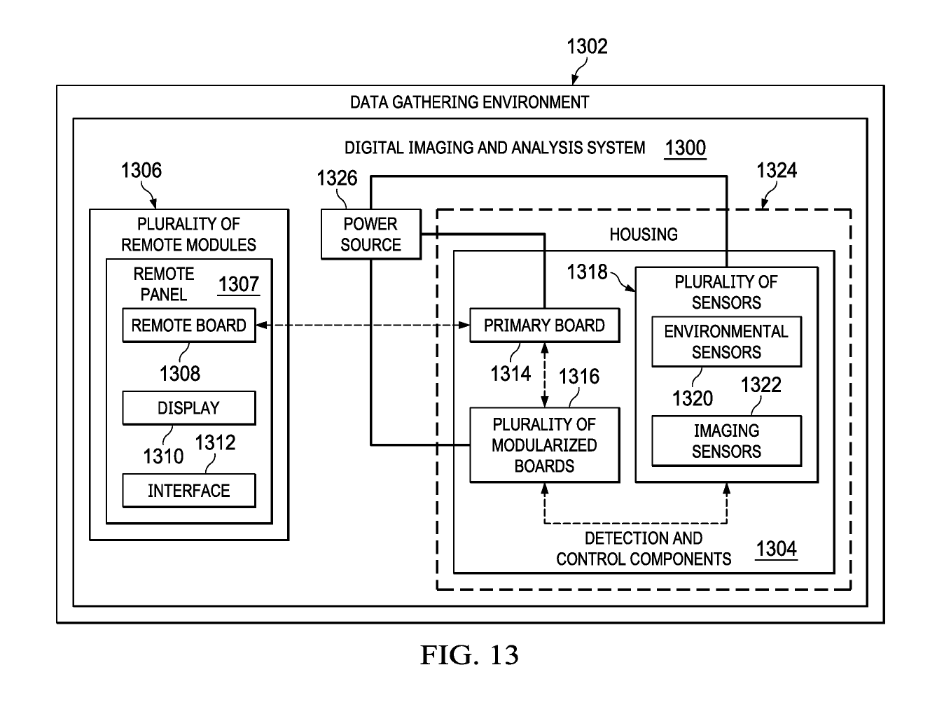

Turning now to FIG. 13, an illustration of a block diagram of a digital imaging and analysis system is depicted in accordance with an illustrative embodiment. Digital imaging and analysis system 1300 is positioned within data gathering environment 1302. Data gathering environment 1302 is any desirable environment in which conditions are monitored. Data gathering environment 1302 may take any desirable form. Digital imaging and analysis system 1300 is configured such that digital imaging and analysis system 1300 may be implemented in rugged and remote environments.

Camera and environmental sensing and logger system 10 of FIG. 1 may be a physical implementation of components of digital imaging and analysis system 1300. Pictorial view 14 of FIG. 2 may be a view of components of digital imaging and analysis system 1300 in data gathering environment 1302. GUI (Graphical User Interface) 30 of FIG. 3 may be used to interact with components of digital imaging and analysis system 1300. Images 40 of FIG. 4 may be images acquired by digital imaging and analysis system 1300 of FIG. 13. Digital imaging and analysis system 300 of FIG. 10, digital imaging and analysis system 301 of FIG. 11, and digital imaging, logging, and analysis system 400 of FIG. 12 are illustrative examples of digital imaging and analysis system 1300.

Digital imaging and analysis system 1300 is configured to activate and integrate plurality of sensors 1318. Digital imaging and analysis system 1300 is configured to provide integration in the data from plurality of sensors 1318, including any desired custom or third party sensors that were not designed to be integrated.

Digital imaging and analysis system 1300 comprises detection and control components 1304 and plurality of remote modules 1306. Plurality of remote modules 1306 is configured to gather data in high frequency and store locally. Plurality of remote modules 1306 are desirably low power systems. As depicted, plurality of remote modules 1306 includes remote panel 1307. Remote panel 1307 allows for an operator to interact with digital imaging and analysis system 1300. As depicted, remote panel 1307 comprises remote board 1308, display 1310, and interface 1312.

The “main system,” including primary board 1314, is desirably as close as it can be to power source 1326 and as close as it can to plurality of sensors 1318. The longer the wires connecting primary board 1314 to power source 1326, the more power reduction. Increasing the length of the wires providing power would also increase the needed power supply. Increasing the length of a power cable may introduce other power regulation requirements.

Also increasing the length of the cable between plurality of sensors 1318 and a designated board, decreases the sensitivity of a sensor. Longer cables would result in delays in triggering the plurality of sensors 1318.

In some illustrative examples, portions of digital imaging and analysis system 1300 are positioned in an area of data gathering environment 1302 undesirably difficult to access, such as on a tower 16 of FIG. 2. In these illustrative examples, remote panel 1307 may allow access for an operator to interact with digital imaging and analysis system 1300 from a more desirable location, such as the base of tower 16 of FIG. 2. By being physically distanced from the “main system” of digital imaging and analysis system 1300, remote board 1308 allows for an operator to interact with the “main system” without introducing delay or decreasing sensitivity of plurality of sensors 1318.

Detection and control components 1304 comprises primary board 1314, plurality of modularized boards 1316, and plurality of sensors 1318. Primary board 1314 and plurality of modularized boards 1316 may be referred to as a “main system.” When an interface to a component is present on a board, that component may be referred to here as “in direct communication” with that board. For example, a sensor with an interface to primary board 1314, such as an image sensor, may be in direct communication with primary board 1314. A sensor that has an interface with a modularized board, such as an analog sensor or a digital sensor may indirectly communicate with primary board 1314 through the modularized board.

Plurality of modularized boards 1316 has any desirable quantity of modularized boards 1316. When present in digital imaging and analysis system 1300, a modularized board enables use of a variety of types of sensors that produce a variety of types of data. When present, a modularized board is configured for the specific types of sensors integrated to modularized board. When present, a modularized board “translates” the sensor output to primary board 1314. A modularized board of plurality of modularized boards 1316 is configured to act as a translator between the needs of the sensor and the needs of the primary board 1314.

A modularized board of plurality of modularized boards 1316 may be used when more than one digital sensor is present in the digital imaging and analysis system containing primary board 1400. In some illustrative examples, a modularized board of plurality of modularized boards 1316 may be used when there is more than one analog sensor. In some illustrative examples, a modularized board is provided for managing a solar panel, a battery, or a power supply.

In some illustrative examples, a modularized board is provided for connecting remote panel 1307 for displaying the status of the digital imaging and analysis system 1300. In some illustrative examples, a modularized board is provided for at least one of communication or DC motor control.

Plurality of sensors 1318 comprises at least one of environmental sensors 1320 or imaging sensors 1322. As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C or item B and item C. In other examples, “at least one of” may be, for example, without limitation, two of item A, one of item B, and ten of item C; four of item B and seven of item C; and other suitable combinations.

Environmental sensors 1320 may take any desirable form including commercial off the shelf or custom temperature, relative humidity, wind speed, wind direction, soil moisture, surface wetness, or other type of environmental sensors. Imaging sensors 1322 may take any desirable form including, but not limited to a visible image sensor, a thermal sensor, a long-wavelength infrared sensor, or any other desirable imaging sensor.

In some illustrative examples, digital imaging and analysis system 1300 comprises housing 1324. Housing 1324 is provided to protect components of detection and control components 1304 from weather and other undesirable effects of data gathering environment 1302. Housing 1324 may be described as a weather-proof housing for easy deployment and maintenance of digital imaging and analysis system 1300 and its protection under harsh conditions.

As depicted, housing 1324 encompasses and protects primary board 1314, plurality of modularized boards 1316, and plurality of sensors 1318. In some other illustrative examples, a subset of plurality of sensors 1318 is present outside of housing 1324. For example, some of environmental sensors 1320 may be present outside of housing 1324 to produce data related to environmental conditions, such as wind speed, rain fall over a given period of time, or other environmental conditions within data gathering environment 1302.

Digital imaging and analysis system 1300 is powered using power source 1326. Power source 1326 takes any desirable form. In some illustrative examples, digital imaging and analysis system 1300 is battery powered. In some illustrative examples, digital imaging and analysis system 1300 is plugged into a line electrical source. In some other illustrative examples, digital imaging and analysis system 1300 utilizes power generated by solar, wind, or another renewable energy source. In these examples, digital imaging and analysis system 1300 may use the power directly or use the power generated by the renewable energy source to recharge existing batteries.

Digital imaging and analysis system 1300 allows for the collection and integration of data from plurality of sensors 1318 by a single system. Digital imaging and analysis system 1300 provides for centralizing control of scheduling and data collection from plurality of sensors 1318 at a single source. Digital imaging and analysis system 1300 thus reduces the complexity of data collection by having a single system to both activate and integrate sensors of different types.

Digital imaging and analysis system 1300 provides for triggering additional collection of data by plurality of sensors 1318 in response to data produced by one or more of plurality of sensors 1318. Additional data collection by a sensor of plurality of sensors 1318 may be triggered directly from a different sensor of plurality of sensors 1318 or by one of primary board 1314 or plurality of modularized boards 1316 in response to data collected by a sensor.

For example, if data gathering environment 1302 rarely receives rainfall, it may be desirable to capture multiple images or other types of data while rain is falling in data gathering environment 1302. In this illustrative example, imaging sensors 1322 may be triggered to take additional images in response to one or more of data from a surface wetness sensor, data from a humidity sensor, or data from an image sensor. In this illustrative example, imaging sensors 1322 may have a higher sampling rate while sensor data is indicative of rain in data gathering environment 1302.

In some illustrative examples, a sensor will communicate directly with other sensors of plurality of sensors to trigger the collection of additional data. In other illustrative examples, one of primary board 1314 or plurality of modularized boards 1316 will trigger the collection of additional data.

The illustration of digital imaging and analysis system in FIG. 13 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, plurality of modularized boards 1316 is not present. In these illustrative examples, primary board 1314 functions independently. In other illustrative examples, detecting and control components 1304 comprises a single modularized board rather than plurality of modularized boards 1316.

As another example, plurality of remote panels 1306 may not be present. In some illustrative examples, remote panel 1307 may be present without additional remote panels.

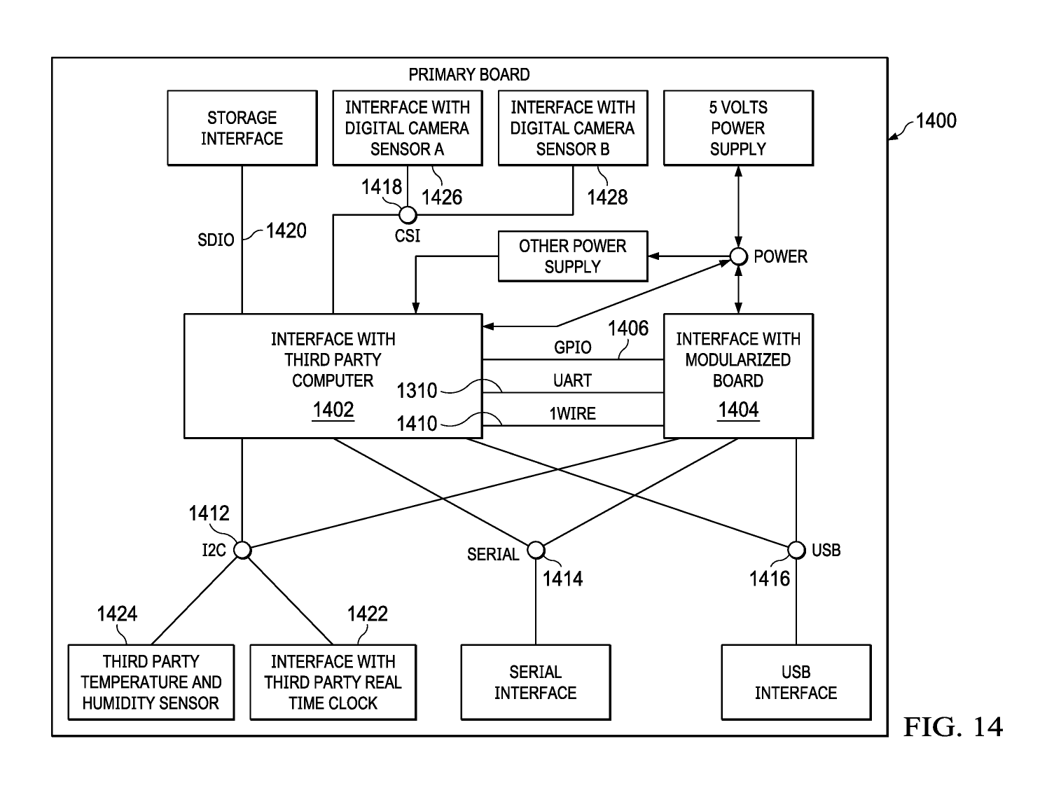

Turning now to FIG. 14, an illustration of a block diagram of a primary board of a digital imaging and analysis system is depicted in accordance with an illustrative embodiment. Primary board 1400 is an implementation of primary board 1314 of digital imaging and analysis system 1300 of FIG. 13.

Primary board 1400 may be a component of camera and environmental sensing and logger system 10 of FIGS. 1 and 2. Primary board 1400 may be present in any of digital imaging and analysis system 300 of FIG. 10, digital imaging and analysis system 301 of FIG. 11, or digital imaging, logging, and analysis system 400 of FIG. 12 to control operations.

In some illustrative examples, primary board 1400 is configured to run independently of other components, such as plurality of remote panels 1306 and plurality of modularized boards 1316 of FIG. 13. In some illustrative examples, primary board 1400 is configured to work in conjunction with one or more modularized boards, such as plurality of modularized boards 1316 of FIG. 3.

As depicted, primary board 1400 hosts third party computer 1402. Third party computer 1402 is desirably a low-cost single-board computer.

As depicted, primary board 1400 interfaces with the modularized board 1404 where the primary board 1400 shares the General Purpose Input/Output (GPIO) 1406, Serial Peripheral Interface (SPI) 1408, 1Wire 1410, Inter-Integrated Circuit (I2C) 1412, Serial 1414, and Universal Serial Bus (USB) 1416 bus.

Primary board 1400 has power. Primary board 1400 can be powered in any desirable fashion. In some illustrative examples, primary board 1400 is powered by standard USB connection. In some illustrative examples, primary board 1400 is powered by a modularized board using interface with the modularized board 1404.

As depicted, lines with arrows on the ends describe the flux of power. If the line doesn't have arrow, the data is bidirectional.

Primary board 1400 has connections with two Camera Serial Interface (CSI) 1418 image sensors, Secure Digital Input/Output (SDIO) 1420 for micro SD card storage or other desirable storage, Real Time Clock (RTC) 1422, and third-party temperature and humidity sensor 1424. Primary board 1400 has two connections for image sensors, interface with digital camera sensor A 1426 and interface with digital camera sensor B 1428. In some illustrative examples, primary board 1400 is positioned within a housing with at least one of a digital camera sensor A or a digital camera sensor B.

Third party temperature and humidity sensor 1424 is connected to the main I2C bus 1412 and if needed, can be read by any modularized board since it is on the main bus. In some illustrative examples, the third-party temperature and humidity sensor 1424 is soldered into primary board 1400. One illustrative use of third party temperature and humidity sensor 1424 is logging temperature and humidity inside of housing 1324 to prevent or detect possible issues with low/high temperature and humidity affecting the third-party computer 1402 or digital camera sensors 1426 or 1428.

The illustration of primary board in FIG. 14 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, if a modularized board is not present, primary board 1400 may not have interface with modularized board 1404. As another example, primary board 1400 may interface with any desirable quantity of camera sensors. In some illustrative examples, primary board 1400 only interfaces with a single camera sensor.

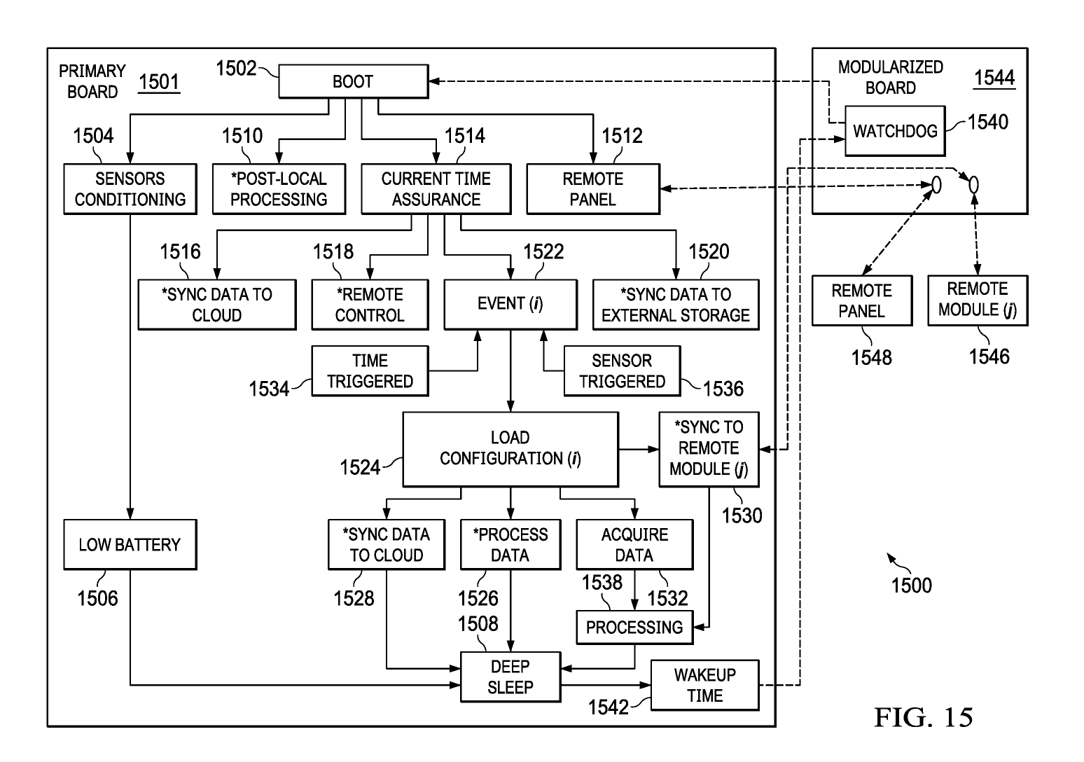

Turning now to FIG. 15, an illustration of a functional block diagram of a primary board of a digital imaging and analysis system is depicted in accordance with an illustrative embodiment. Functional block diagram 1500 is an illustration of the functions performed by primary board 1314 of digital imaging and analysis system 1300 of FIG. 13.

Functional block diagram 1500 may be described as a diagram of the firmware in primary board computer, such as third-party computer 1402. In some illustrative examples, functional block diagram 1500 may be described as the main internal process of primary board 1501.

Primary board 1501 may be an implementation of primary board 1314 of FIG. 13. Primary board 1501 may be the same as primary board 1400 of FIG. 14.

The third-party computer, such as third-party computer 1402, boots 1502. After booting 1502, one of four sequences may be performed. The performance of one of the sequences of primary board 1501 is performed after an operating system loads.

Sensors conditioning 1504 sequence is one of the four sequences depicted in FIG. 15. Sensors conditioning 1504 sequence checks the battery voltage. In some illustrative examples, sensors conditioning 1504 sequence also warms the system to get accurate data from sensors.

If the battery voltage is low 1506, the sequence sends the primary board to deep sleep 1508 mode. The last part of this sequence is working while the main system is powered on.

Post-local processing 1510 is another sequence depicted in FIG. 15. Post-local processing 1510 is performed when there pending processes needed for the local data.

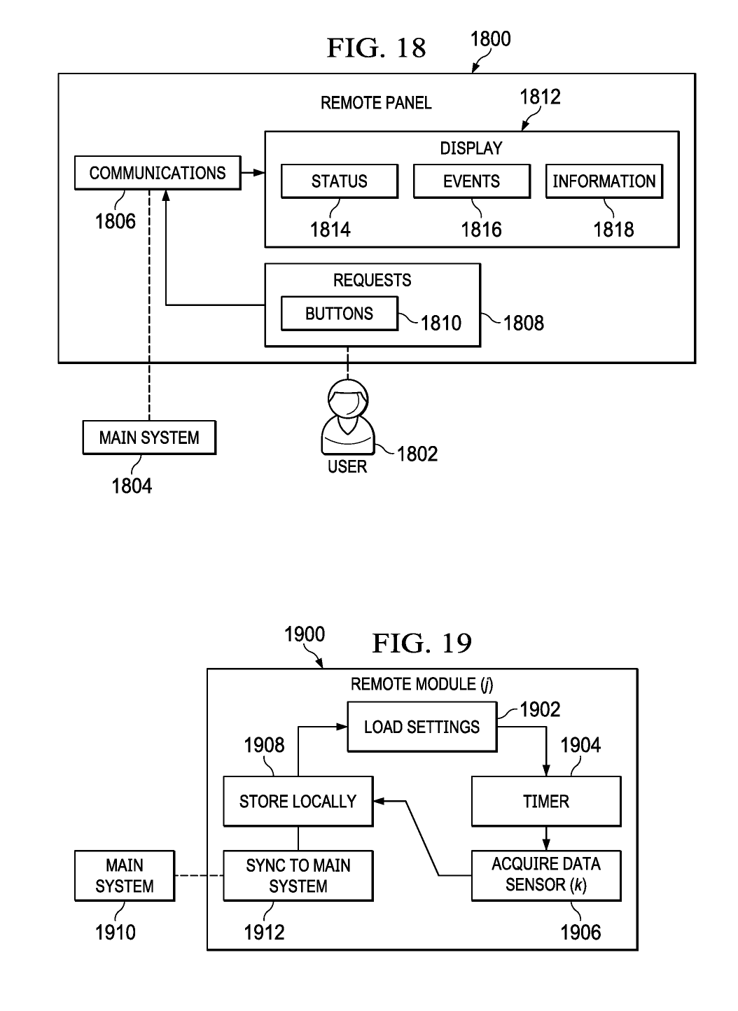

A driver for remote panel 1512 is a third sequence depicted in FIG. 15. The remote panel 1512 sequence is running while the main system is powered. The remote panel 1512 sequence is the driver for the remote panel, such as remote panel 1307 of FIG. 13 or remote panel 1800 of FIG. 18.

Another sequence is current time assurance 1514. Current time assurance 1514 checks if the time is correct and corrected in the main system. Current time assurance 1514 ideally only takes a few milliseconds to be completed. After current time assurance 1514 is finished, the main system is ready and waiting for additional actions.

After current time assurance 1514 is finished, the main system is ready and waiting for sync data to the cloud 1516, remote control 1518, sync data to external storage 1520 if it is present, and execute all the events 1522 when are triggered.

In this illustrative example, the sequences are running and managed by the OS. There could be “n” events 1522 that each has its own configuration file 1524. The events 1522 may be process data 1526, sync data 1528 that could be raw or processed to the cloud, sync to remote module “j” 1530 to get data from it, and acquire data 1532. To begin an event, primary board 1501 loads the configuration “i” 1524 for the desired event of process data 1526, sync data to cloud 1528, sync to remote module “j” 1530, or acquire data 1532.

Acquire data 1532 could be performed by any desirable sensor associated directly or indirectly with primary board 1501. For example, acquire data 1532 could be to take picture in RGB, NIR, and/or LWIR, or take video in RGB and/or NIR. After all the events 1522 for that period of time ends, the main system determines if it is need to go to deep sleep 1508 to save power.

Each event “i” 1522 can be triggered by time 1534 or by a sensor 1536 directly attached to the main system. When an event “i” is sensor triggered 1536, additional scenario specific data may be collected. When an event “i” is sensor triggered 1536, the system collects data that would not have been collected according to the programmed sampling plan.

Event “i” 1522 may be sensor triggered 1536 when environmental thresholds from one or more of the sensors linked to the primary board 1501 directly or indirectly, through a modularized board, can be programmed to trigger the camera systems. Environmental thresholds may be, for example, maximum values or minimum values for temperature, humidity, wind speed, or any other environmental measurement. In some illustrative examples, environmental thresholds may include a maximum range of values for a period of time. For example, an environmental threshold may be a maximum range of temperatures, humidities, or environmental measurement over an hour, a day, a week, or a month.

All the data collected is processed 1538 and stored locally to be ready to sync to the cloud 1516 and/or external storage 1520. When the main system is in deep sleep 1508, there is a watchdog 1540 checking for next time to wake up 1542 and battery voltage. Watchdog 1540 is implemented as an algorithm or software module. In some non-depicted illustrative examples, watchdog 1540 is implemented on primary board 1501.

As depicted, watchdog 1540 is implemented on modularized board 1544. Modularized board 1544 also has interfaces for remote module 1546 and remote panel 1548. In this illustrative example, to perform remote panel 1512 sequence, primary board 1501 utilizes the interface of modularized board 1544 and remote panel 1548. In this illustrative example, to perform sync to remote module (j) 1530, primary board 1501 utilizes the interface of modularized board 1544 and remote module (j) 1546.

The sequences identified with an asterix are optional. The items identified with an asterix, *, are performed if programmed or needed. In some illustrative examples, the sequences identified with an asterix are not performed.

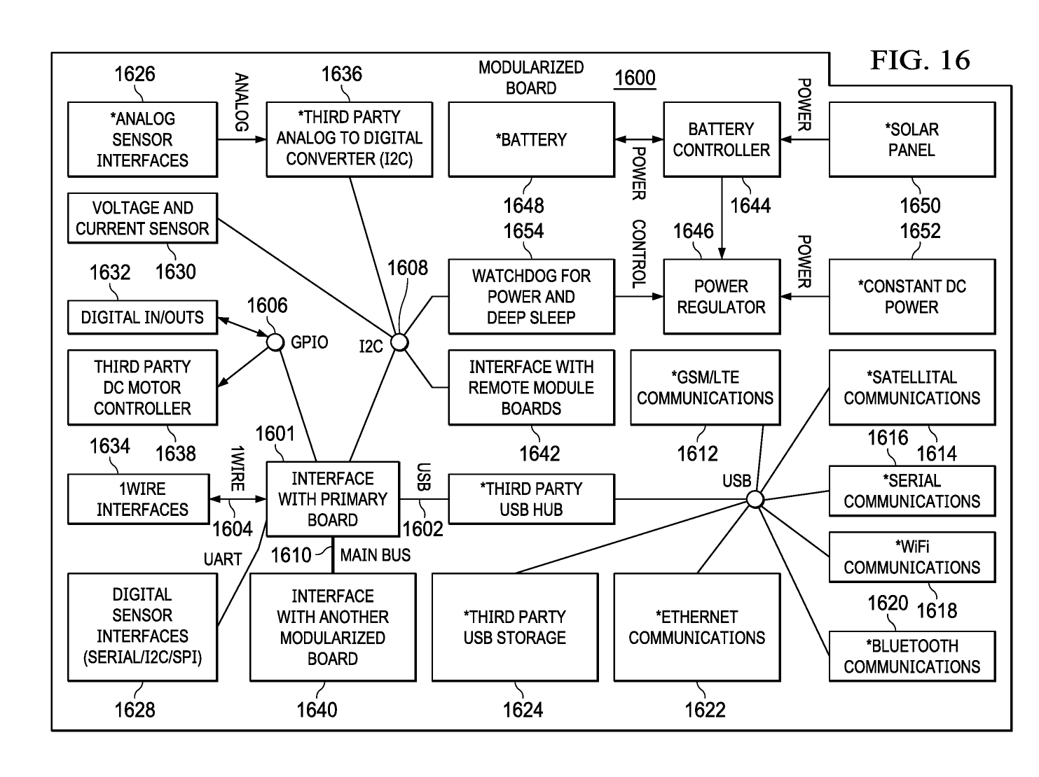

Turning now to FIG. 16, an illustration of a diagram of a modularized board of a digital imaging and analysis system is depicted in accordance with an illustrative embodiment. Modularized board 1600 is an implementation of a modularized board of plurality of modularized boards 1316 of digital imaging and analysis system 1300 of FIG. 13. Modularized board 1600 may be an implementation of modularized board 1544 of FIG. 15.

Modularized board 1600 may be a component of camera and environmental sensing and logger system 10 of FIGS. 1 and 2. Modularized board 1600 may be present in any of digital imaging and analysis system 300 of FIG. 10, digital imaging and analysis system 301 of FIG. 11, or digital imaging, logging, and analysis system 400 of FIG. 12 to control operations.

Modularized board 1600 is connected to a primary board, such as primary board 1400, at interface 1601, where it shares USB 1602, 1Wire 1604, GPIO 1606, I2C 1608, SPI, and serial bus 1610.

Modularized board 1600 is used for communications. Communications may include at least one of GSM/LTE communications 1612, satellital communications 1614, serial communications 1616, wifi communications 1618, Bluetooth communications 1620, or Ethernet communications 1622.

Modularized board 1600 has storage. In this illustrative example, storage takes the form of third party USB storage 1624.

In some illustrative examples, modularized board 1600 interfaces with multiple sensors. Modularized board 1600 may interface with any desirable type of sensor with any desirable input/output. As depicted, modularized board 1600 may include at least one of analog sensor interfaces 1626, digital sensor interfaces 1628, voltage current sensor 1630, digital in/outs 1632, and 1wire interfaces 1634. Modularized board 1600 also includes any desirable components to “translate” the data from the sensors and the triggers from the primary board to the sensors. As depicted, modularized board 1600 includes third party analog to digital converter 1636.

Modularized board 1600 may also control any actuators associated with sensors. Modularized board 1600 may also control any actuators associated with components of the digital imaging and analysis system. In these illustrative examples, modularized board 1600 may have third party DC motor controller 1638.

In some illustrative examples, the digital imaging and analysis system comprises more than one modularized board. In these illustrative examples, modularized board 1600 is connected with other modularized boards at interface with another modularized board 1640.

Modularized board 1600 also has interface with remote module boards 1642. When the primary board is in deep sleep mode, modularized board 1600 may communicate with remote module boards 1642 directly.

In some illustrative examples, modularized board 1600 also monitors and regulates power from battery 1648, solar panel 1650, or constant suppliers such as constant DC power 1652. As depicted, modularized board 1600 may have battery controller 1644 and power regulator 1646 to monitor and regulate power from battery 1648. Battery controller 1644 may also regulate charging of battery 1648 by solar panel 1650 or other power generator. In some illustrative examples, modularized board 1600 also includes watchdog for power and deep sleep 1654. Watchdog 1654 may be an implementation of watchdog 1540 of FIG. 15.

The illustration of modularized board 1600 in FIG. 16 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

This figure shows modularized board 1600 with many components. Several of the components may be optional. For example, the items marked with an asterix may be optional components. For example, in some layouts, modularized board may not have constant DC power 1652.

Some implementations of modularized board 1600 may have significantly fewer components than illustrated in FIG. 16. For example, one implementation of modular board 1600 may have only interface with the primary board 1601, the watchdog for power and deep sleep 1654, power regulator 1646, constant DC power input 1652, 1Wire 1604, and digital sensor interface 1628.

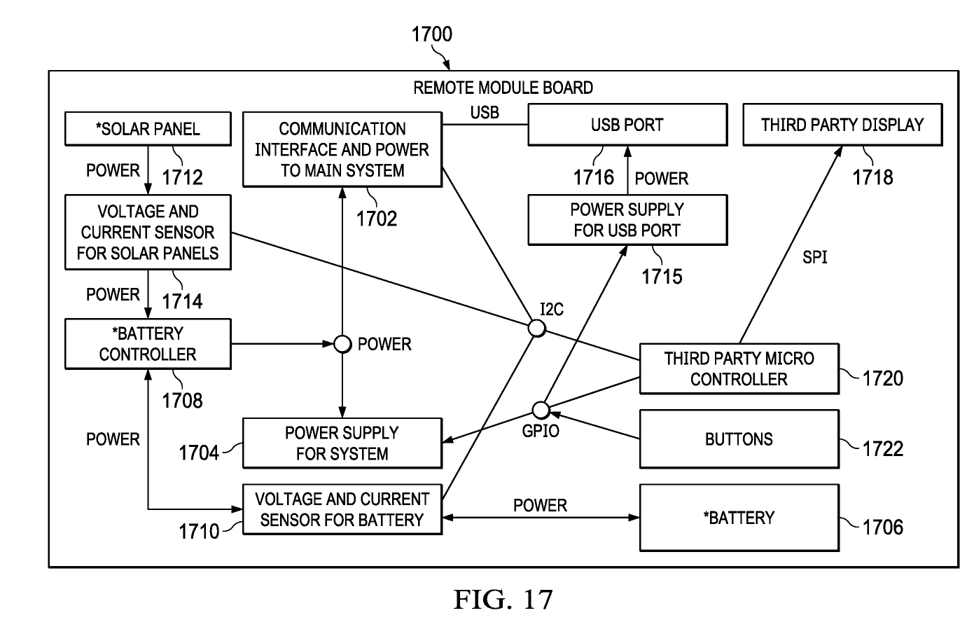

Turning now to FIG. 17, an illustration of a diagram of a remote module board of a digital imaging and analysis system is depicted in accordance with an illustrative embodiment. Remote module board 1700 is an implementation of a board for remote panel 1307 of digital imaging and analysis system 1300 of FIG. 13. Remote module board 1700 is an implementation of a board for one of plurality of remote modules 1306 of FIG. 13.

Remote module board 1700 is connected to the “main system,” through either the primary board or a modularized board, if present. In some illustrative examples, remote module board 1700 is connected to a modularized board, such as modularized board 1600, using a cable, such as a third party 8 lines twisted pair cable. Remote module board 1700 has communication interface and power to main system 1702.

In some illustrative examples, remote module board 1700 has its own power supply, such as battery 1706. In some illustrative examples, remote module board 1700 can be powered by power supply for system 1704. In some illustrative examples, remote module board 1700 is powered by the power supply for the modularized board.

Remote module board 1700 can monitor and control the power from batteries, solar panels, or constant suppliers. Remote module board 1700 has associated power control and monitoring components. In some illustrative examples, remote module board 1700 has at least one of battery controller 1708 or voltage and current sensor for battery 1710. In some illustrative examples, remote module board 1700 is associated with solar panel 1712 for providing power or recharging battery 1706. Remote module board 1700 has voltage and current sensor for solar panels 1714 when solar panel 1712 is associated with remote module board 1700.

As depicted, remote module board 1700 also has USB port 1716 and power supply for USB port 1715. In some illustrative examples, an operator may provide input or receive output from remote module board 1700 through USB port 1716.

Remote module board 1700 can contain a third-party micro display 1718 to show basic relevant information of the primary board computer. When the main board computer is in deep sleep mode, the modularized board can control and send data to display to the remote module board 1700. The remote module board 1700 can send request to the primary board to enter or exit deep sleep mode or control basic operations provided by third party microcontroller 1720. An operator may interact with remote module board using buttons 1722.

The illustration of remote module board 1700 in FIG. 17 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, the items marked with an Asterix may be optional. Further, different remote modules may perform different functions.

In some illustrative examples, remote module board 1700 is implemented in remote panel 1800 of FIG. 18. In some illustrative examples, remote module board 1700 is implemented in remote module 1900 of FIG. 19. In these illustrative examples, remote module 1900 may not include a third-party display as its primary function is storage of sensor data.

Turning now to FIG. 18, an illustration of a functional diagram of a remote panel is depicted in accordance with an illustrative embodiment. Remote panel 1800 is an implementation of remote module 1306. Remote panel 1800 uses an implementation of remote module board 1700.

In FIG. 18, user 1802 can see basic info from main system 1804 at remote panel 1800. Remote panel 1800 has communications 1806 with main system 1804. In some illustrative examples, communications 1806 include requests 1808 user 1802 sends to main system 1804 using any desired input device. In some illustrative examples, user 1802 sends requests 1808 using buttons 1810.

The diagram shows remote panel 1800 where a user 1802 can see basic info from the main system and request to enter or exit of deep sleep mode. Display 1812 could be used to display status 1814 of the main system. Display 1812 may also be used to view or modify events 1816 to be performed by a primary board of the main system. Display 1812 may display additional information 1818 such as a prompt to save or request sensor data. In some illustrative examples, the remote panel 1800 could be positioned far from the main system.

Turning now to FIG. 19, an illustration of a functional diagram of a remote module is depicted in accordance with an illustrative embodiment. Remote module 1900 is an implementation of one of plurality of remote modules 1306. Remote module 1900 is an implementation of remote module board 1700.

Remote module 1900 is configured to collect data from multiple sensors, such as plurality of sensors 1318. FIG. 19 illustrate a remote module internal process and the system can support “m” remote modules. Remote module 1900 is a low power minimal system. As depicted, the main purpose of remote module 1900 is to gather data in high frequency and store locally. Remote module 1900 can manage multiple sensors. Later, the main system can get the data from the remote module.

Internally, remote module 1900 loads settings 1902 and, based on timer 1904, acquires data from sensors 1906 analog and/or digital sensors attached to the remote module. Then, the data is stored locally 1908. Data stored locally is accessible to the main system 1910 when remote module 1900 syncs to main system 1912. In some illustrative examples, main system 1910 comprises a primary board. In some illustrative examples, main system 1910 comprises a primary board and at least one modularized board.

Remote module 1900 is connected to main system 1910 in any desirable fashion. In some illustrative examples, remote module 1900 is distanced from main system 1910 through a cable. The cable may allow remote module 1900 be positioned far from the main system. In one illustrative example, remote module 1900 may be 10 meters or more from the main system.

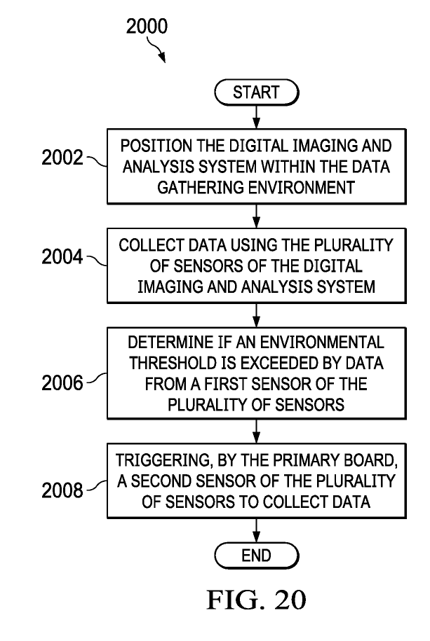

FIG. 20 is an illustration of a flowchart for monitoring a data gathering environment using a digital imaging and analysis system in accordance with an illustrative embodiment. Method 2000 may be implemented using digital imaging and analysis system of FIG. 13. Method 2000 may be implemented using any of primary board 1400 of FIG. 14, modularized board 1600 of FIG. 16, remote module board 1700 of FIG. 17, or any other desirable components depicted in the Figures.

Method 2000 positions the digital imaging and analysis system within the data gathering environment (operation 2002). In method 2000, the digital imaging and analysis system comprises detection and control components in communication with each other, the detection and control components comprising a plurality of sensors and a primary board in direct or indirect communication with the plurality of sensors.

Method 2000 collects data using the plurality of sensors of the digital imaging and analysis system (operation 2004). In method 2000 the plurality of sensors is configured to gather at least one of environmental data or images.

Method 2000 determines if an environmental threshold is exceeded by data from a first sensor of the plurality of sensors (operation 2006). Method 2000 triggers, by the primary board, a second sensor of the plurality of sensors to collect data (operation 2008). Method 2000 triggers the second sensor in response to a determination that an environmental threshold was exceeded by the data from the first sensor. In some illustrative examples, the second sensor is an imaging sensor.

In some illustrative examples, method 2000 further stores the data from the plurality of sensors locally at a remote module displaced a distance from the detection and control components, wherein the remote panel is communicatively connected to the detection and control components by a cable. In some illustrative examples, method 2000 also sends a request to the primary board from a remote panel displaced a distance from the detection and control components, wherein the remote panel is communicatively connected to the detection and control components by a cable, and wherein the remote panel comprises a display for showing information of the primary board.

In some illustrative examples, the plurality of sensors comprises an imaging sensor and at least one of an analog sensor or a digital sensor. In these illustrative examples, method 2000 further comprises processing the data from the at least one of the analog sensor or the digital sensor at a modularized board interfaced with the primary board. In some illustrative examples, method 2000 further comprises integrating data from the plurality of sensors using the primary board and the modularized board, wherein the modularized board shares at least one of General Purpose Input/Output (GPIO), Serial Peripheral Interface (SPI), 1Wire, Inter-Integrated Circuit (I2C), Serial, or Universal Serial Bus (USB) bus with the primary board.

In some illustrative examples, method 2000 further comprises placing the primary board into a deep sleep state after triggering the second sensor; and monitoring for a next time to wake using a watchdog of the modularized board while the primary board is in the deep sleep state.

A digital imaging and analysis system configured to provide sensor triggered events is presented. The digital imaging and analysis system comprises a detection and control components in communication with each other. The detection and control components comprise a plurality of sensors configured to gather at least one of environmental data or images; and a primary board in direct or indirect communication with the plurality of sensors and configured to trigger one of the plurality of sensors in response to another of the plurality of sensors exceeding an environmental threshold.

In some illustrative examples, the digital imaging and analysis system further comprises a remote panel displaced a distance from the detection and control components, wherein the remote panel is communicatively connected to the detection and control components by a cable, and wherein the remote panel comprises a display for showing information of the primary board.

In some illustrative examples, the digital imaging and analysis system further comprises a remote module displaced a distance from the detection and control components, wherein the remote module is communicatively connected to the detection and control components by a cable, and wherein the remote module is configured to gather data from plurality of sensors and store the data locally. In some illustrative examples, the plurality of sensors comprises an image sensor and at least one of an analog sensor or a digital sensor, and the detection and control components further comprise: a modularized board configured to integrate the at least one of the digital sensor or the analog sensor with the image sensor.

In some illustrative examples, the digital imaging and analysis system further comprises a housing surrounding the primary board, the modularized board, and the image sensor, wherein the housing is a weather proof housing. In some illustrative examples, the modularized board shares at least one of General Purpose Input/Output (GPIO), Serial Peripheral Interface (SPI), 1Wire, Inter-Integrated Circuit (I2C), Serial, or Universal Serial Bus (USB) bus with the primary board.

The illustrative examples provide a digital imaging and analysis system 1300 configured to integrate data from a plurality of sensors of different types. The digital imaging and analysis system 1300 comprises the plurality of sensors configured to gather at least one of environmental data or images, the plurality of sensors comprising an image sensor and at least one of an analog sensor or a digital sensor; a primary board in direct communication with the image sensor and having an interface to a modularized board; and the modularized board, wherein the modularized board is in direction communication with the at least one of the analog sensor or the digital sensor.

In some illustrative examples, the primary board and the modularized board form a main system, and the digital imaging and analysis system further comprises a remote panel displaced a distance from the main system, wherein the remote panel is communicatively connected to the main system by a cable, and wherein the remote panel comprises a display for showing information of the primary board. In some illustrative examples, the remote panel, such as 1700 or 1800 is configured to communicate with the modularized board when the primary board is in a deep sleep mode.

In some illustrative examples, the primary board and the modularized board form a main system, and the digital imaging and analysis system further comprises a remote module 1700 or 1900 displaced a distance from the main system, wherein the remote module is communicatively connected to the main system by a cable, and wherein the remote module is configured to gather data from plurality of sensors and store the data locally. In some illustrative examples, the digital imaging and analysis system further comprises a housing surrounding the primary board, the modularized board, and the image sensor, wherein the housing is a weather proof housing. In some illustrative examples, the primary board and the modularized board form a main system, the digital imaging and analysis system further comprising a communications system configured to sync data from the main system to the cloud. For example, modularized board 1600 is configured for communications as depicted. In some illustrative examples, modularized board 1600 may interact with a separate communications system. In some illustrative examples, the modularized board shares at least one of General Purpose Input/Output (GPIO), Serial Peripheral Interface (SPI), 1Wire, Inter-Integrated Circuit (I2C), Serial, or Universal Serial Bus (USB) bus with the primary board.

The illustrative examples provide a digital imaging and analysis system that provides several advantages conventional sensors. The illustrative examples provide a system for integrating a plurality of different types of sensors. The system may translates the “needs” of some of the sensors for input and power at a modularized board.

The illustrative examples provide a digital imaging and analysis system configured to provide integration in the data from a plurality of sensors, including any desired custom or third-party sensors that were not designed to be integrated.

Additionally, the illustrative examples provide a system configured to trigger a sensor in response to data collected from a different sensor of the system. The illustrative examples provide for sensor triggered events when an environmental threshold is reached. By providing for sensor triggered events, additional data is collected that would not have been collected in a timed collection plan. By providing for sensor triggered events, digital imaging and analysis system has greater utility than conventional sensor systems. By providing for sensor triggered events, digital imaging and analysis system provides operators data relevant to the unique circumstances the operator is monitoring.

It will be appreciated that variations of the above-disclosed and other features and functions, or alternatives thereof, may be desirably combined into many other different systems or applications. Also, it will be appreciated that various presently unforeseen or unanticipated alternatives, modifications, variations or improvements therein may be subsequently made by those skilled in the art which are also intended to be encompassed by the following claims.

What is claimed is:

1. A digital imaging and analysis system configured to provide sensor triggered events, the system comprising:
detection and control components in communication with each other, the detection and control components comprising:
a plurality of sensors configured to gather at least one of environmental data or images; and
a primary board in direct or indirect communication with the plurality of sensors and configured to trigger one of the plurality of sensors in response to another of the plurality of sensors exceeding an environmental threshold.

2. The digital imaging and analysis system of claim 1 further comprising:
a remote panel displaced a distance from the detection and control components, wherein the remote panel is communicatively connected to the detection and control components by a cable, and wherein the remote panel comprises a display for showing information of the primary board.

3. The digital imaging and analysis system of claim 1 further comprising:
a remote module displaced a distance from the detection and control components, wherein the remote module is communicatively connected to the detection and control components by a cable, and wherein the remote module is configured to gather data from plurality of sensors and store the data locally.

4. The digital imaging and analysis system of claim 1 wherein the plurality of sensors comprises an image sensor and at least one of an analog sensor or a digital sensor, and wherein the detection and control components further comprise:
a modularized board configured to integrate the at least one of the digital sensor or the analog sensor with the image sensor.

5. The digital imaging and analysis system of claim 4 further comprising:
a housing surrounding the primary board, the modularized board, and the image sensor, wherein the housing is a weather proof housing.

6. The digital imaging and analysis system of claim 4 wherein the modularized board shares at least one of General Purpose Input/Output (GPIO), Serial Peripheral Interface (SPI), 1Wire, Inter-Integrated Circuit (I2C), Serial, or Universal Serial Bus (USB) bus with the primary board.

7. A method of monitoring a data gathering environment using a digital imaging and analysis system, the method comprising:
positioning the digital imaging and analysis system within the data gathering environment, wherein the digital imaging and analysis system comprises detection and control components in communication with each other, the detection and control components comprising a plurality of sensors and a primary board in direct or indirect communication with the plurality of sensors;
collecting data using the plurality of sensors of the digital imaging and analysis system, wherein the plurality of sensors is configured to gather at least one of environmental data or images;
determining if an environmental threshold is exceeded by data from a first sensor of the plurality of sensors; and
triggering, by the primary board, a second sensor of the plurality of sensors to collect data in response to a determination that an environmental threshold was exceeded by the data from the first sensor.

8. The method of claim 7, wherein the second sensor is an imaging sensor.

9. The method of claim 7 further comprising:
storing the data from the plurality of sensors locally at a remote module displaced a distance from the detection and control components, wherein the remote panel is communicatively connected to the detection and control components by a cable.

10. The method of claim 7 further comprising:
sending a request to the primary board from a remote panel displaced a distance from the detection and control components, wherein the remote panel is communicatively connected to the detection and control components by a cable, and wherein the remote panel comprises a display for showing information of the primary board.

11. The method of claim 7 wherein the plurality of sensors comprises an imaging sensor and at least one of an analog sensor or a digital sensor, the method further comprising:
processing the data from the at least one of the analog sensor or the digital sensor at a modularized board interfaced with the primary board.

12. The method of claim 11 further comprising:
integrating data from the plurality of sensors using the primary board and the modularized board, wherein the modularized board shares at least one of General Purpose Input/Output (GPIO), Serial Peripheral Interface (SPI), 1Wire, Inter-Integrated Circuit (I2C), Serial, or Universal Serial Bus (USB) bus with the primary board.

13. The method of claim 11 further comprising:
placing the primary board into a deep sleep state after triggering the second sensor; and
monitoring for a next time to wake using a watchdog of the modularized board while the primary board is in the deep sleep state.

14. A digital imaging and analysis system configured to integrate data from a plurality of sensors of different types, the system comprising:
the plurality of sensors configured to gather at least one of environmental data or images, the plurality of sensors comprising an image sensor and at least one of an analog sensor or a digital sensor;
a primary board in direct communication with the image sensor and having an interface to a modularized board; and
the modularized board, wherein the modularized board is in direction communication with the at least one of the analog sensor or the digital sensor.

15. The digital imaging and analysis system of claim 14, wherein the primary board and the modularized board form a main system, the digital imaging and analysis system further comprising:
a remote panel displaced a distance from the main system, wherein the remote panel is communicatively connected to the main system by a cable, and wherein the remote panel comprises a display for showing information of the primary board.

16. The digital imaging and analysis system of claim 15, wherein the remote panel is configured to communicate with the modularized board when the primary board is in a deep sleep mode.

17. The digital imaging and analysis system of claim 14, wherein the primary board and the modularized board form a main system, the digital imaging and analysis system further comprising:
a remote module displaced a distance from the main system, wherein the remote module is communicatively connected to the main system by a cable, and wherein the remote module is configured to gather data from plurality of sensors and store the data locally.

18. The digital imaging and analysis system of claim 14 further comprising:
a housing surrounding the primary board, the modularized board, and the image sensor, wherein the housing is a weather proof housing.

19. The digital imaging and analysis system of claim 14, wherein the primary board and the modularized board form a main system, the digital imaging and analysis system further comprising:
a communications system configured to sync data from the main system to the cloud.

20. The digital imaging and analysis system of claim 14 wherein the modularized board shares at least one of General Purpose Input/Output (GPIO), Serial Peripheral Interface (SPI), 1Wire, Inter-Integrated Circuit (I2C), Serial, or Universal Serial Bus (USB) bus with the primary board.
